(19) United States
(12) Patent Application Publication
(10) Pub. No.: US 2016/0026641 A1
(43) Pub. Date: Jan. 28, 2016

(54) SYSTEM AND METHOD TO DISPLAY SEARCH SPECIFIC PAGES

(71) Applicant: Shocase, Inc., San Francisco, CA (US)

(72) Inventors: Ronald P. Young, Mill Valley, CA (US); David Anthony Burgess, Menlo Park, CA (US); Peter Rugg, new York, NY (US)

(21) Appl. No.: 14/807,229

(22) Filed: Jul. 23, 2015

Related U.S. Application Data
(60) Provisional application No. 62/028,341, filed on Jul. 24, 2014.

(51) Int. Cl. G06F 17/30; H04L 29/06; G06Q 50/00; H04L 29/08

(52) U.S. Cl. CPC G06F 17/3053; H04L 67/30; H04L 65/403; G06F 17/30905; G06Q 50/01

(57) ABSTRACT

Methods, systems, and media are directed to providing dynamically optimized search results in conjunction with a social networking site. The dynamically optimized search includes a search utility of the social networking site to receive search criteria, a processing unit configured to execute a profile search of profile pages that match the search criteria, to rank the profile search results, in view of the search criteria, and to compile an interim list of relevant profile information. The processing unit is also configured to select highest ranking results of the interim list of relevant profile information and extract associated profile information therefrom, and to rank the extracted profile information, in view of the search criteria, to provide optimized content. A display unit displays the customized profile pages to present the optimized content, in which the customized profile pages are configured to prominently display the optimized content in accordance with the search criteria.

### CROSS-REFERENCE TO RELATED APPLICATIONS

This Application claims priority to U.S. Provisional Patent Appln. Ser. No. 62/028,341, filed Jul. 24, 2014 entitled, “SYSTEM AND METHOD TO DISPLAY SEARCH SPECIFIC PAGES.”

This Application is also related to U.S. Appln. Ser. No. 14/507,003, filed Oct. 6, 2014 entitled, “SYSTEM AND METHOD TO PROVIDE COLLABORATION TAGGING FOR VERIFICATION AND VIRAL ADOPTION,” which claims priority to U.S. Provisional Patent Appln. Ser. No. 61/887,423, filed Oct. 6, 2013 entitled, “A SYSTEM AND METHOD TO PROVIDE COLLABORATION TAGGING FOR VIRAL VERIFICATION AND ADOPTION.”

### FIELD OF THE INVENTION

The present invention generally relates to aspects of social networking site platforms and, more particularly, to the automatic presentation of dynamically optimized profile search results on a social network responsive to search query criteria.

### BACKGROUND OF THE INVENTION

Social networking sites are commonly used by individuals and companies on the Internet for many different purposes. Companies, organizations, and individuals are capable of setting up profiles on these sites that include basic information, projects, awards, collaboration with others, etc., Such information can then be viewed by other registered site users, as individuals can search the social network to pull up profiles, projects and portfolios of interest.

Some social networking sites also provide searching capabilities that enable registered users to enter search criteria and receive a webpage displaying the search results. Typically, the search results are displayed with a search-specific static layout.

It will be appreciated, however, that conventional systems and processes do not present search result information in an optimized fashion relative to specific search criteria.

### SUMMARY OF THE INVENTION

The invention, as disclosed herein, addresses the deficiencies and drawbacks noted above by providing systems and methods that are directed to the automatic presentation of dynamically optimized profile search results on a social network responsive to search query criteria. The present invention is capable of being deployed on any social network where companies or people are registered users. Such social networks may focus or have sub focus on any business or leisure endeavor, including but not limited to autos, energy, entertainment, professional services, manufacturing, distribution and sales, art, performance, sports, competitive games, intellectual pursuits, or government service to name but a few.

Methods, systems, and media are directed to providing dynamically optimized search results in conjunction with a social networking site. The provision of dynamically optimized search includes a search utility of the social networking site to receive search criteria, a processing unit configured to execute a profile search of profile pages that match the search criteria, to rank the profile search results, in view of the search criteria, and to compile an interim list of relevant profile information. The processing unit is also configured to select highest ranking results of the interim list of relevant profile information and extract associated profile information therefrom, and to rank the extracted profile information, in view of the search criteria, to provide optimized content. A display unit displays the customized profile pages to present the optimized content in which the customized profile pages are configured to prominently display the optimized content in accordance with the search criteria.

In so doing, the disclosed methods, systems, and media present results based on search-specific criteria in addition to the relationship to the searcher's profile information (e.g. industry, location, company, etc.) and/or searcher's contacts, connections, and collaborators.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1A depicts a flowchart for a user-generated search process within a social networking site that results in dynamically optimized profile information, in accordance with various aspects of the present disclosure.

FIG. 1B depicts a flowchart for a user-generated search process that that results in dynamically optimized profile information on the Internet, in accordance with various aspects of the present disclosure.

FIG. 2 (Prior Art) depicts a default company profile webpage.

FIG. 3 depicts a dynamically optimized profile based on a search query including defining elements, in accordance with various aspects of the present disclosure.

FIG. 4 depicts another dynamically optimized profile of a company based on a search query including other defining elements, in accordance with various aspects of the present disclosure.

FIG. 5 (Prior Art) depicts a default individual user's profile webpage.

FIG. 6 depicts an individual user's profile webpage after being dynamically optimized and re-formatted to be specifically responsive to the elements in a search query, in accordance with various aspects of the present disclosure.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

As will be apparent by the ensuing description and illustrations, the disclosed embodiments relate to the automatic presentation of dynamically optimized profile search results on a social network responsive to search query criteria.

By way of review, companies, individuals, or organizations first create a profile that includes basic information, projects, awards, specialization data, collaboration with others, etc. Collaborators on projects may be tagged in the profile, and users may access the profiles of these collaborators. Since the power of social networking has been proven to be a successful component of business and friendship development, users are eager to provide information and update their profiles on a regular basis. Typically, social networking sites present the company or individual information in chronological order.

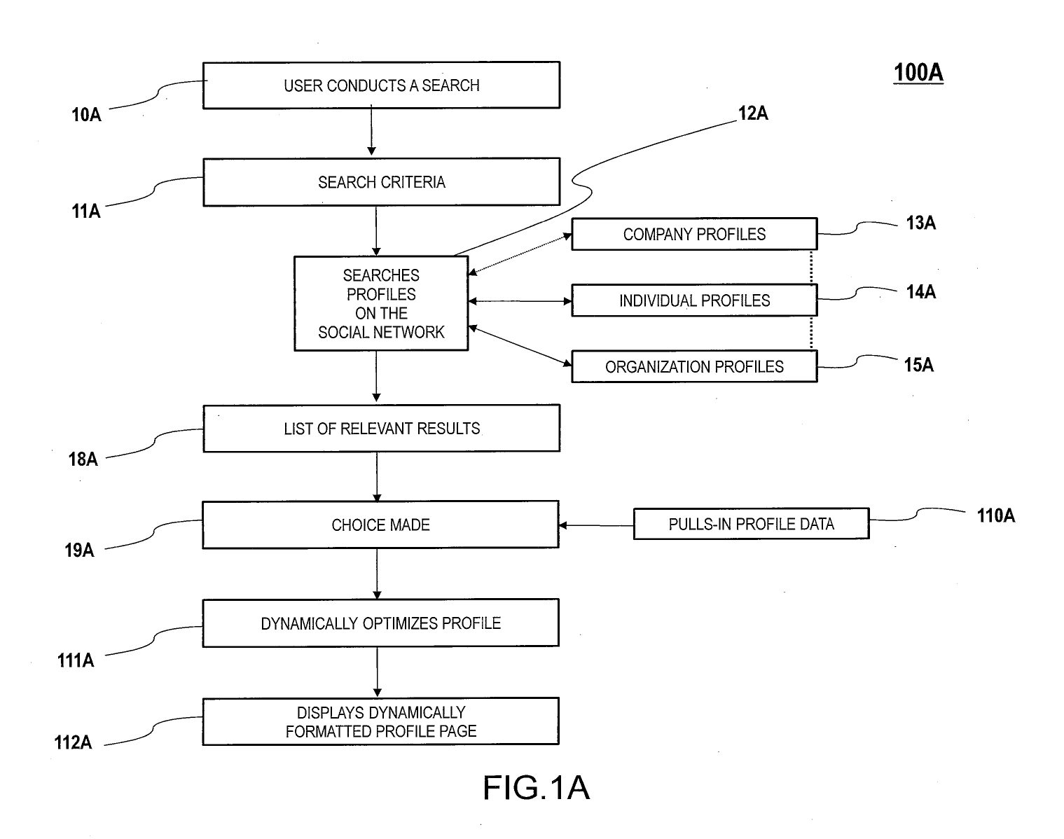

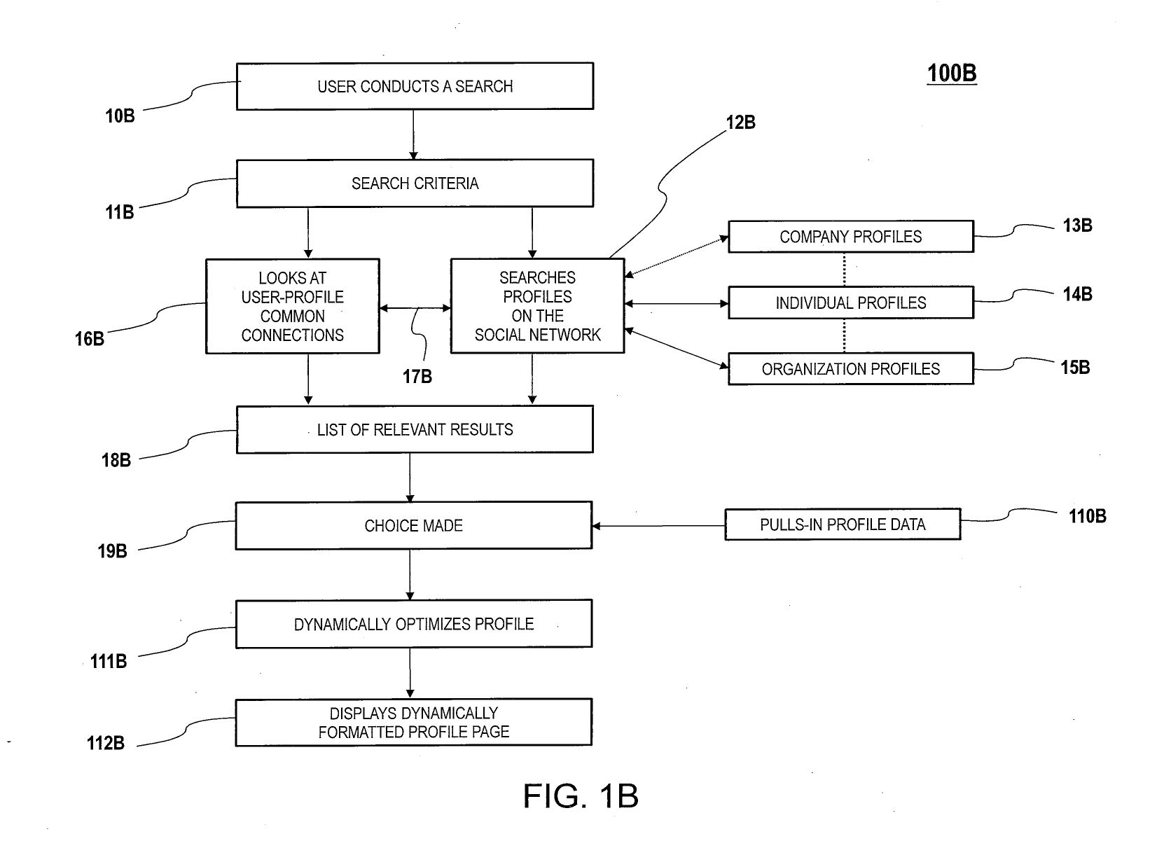

To this end, FIG. 1A depicts user-generated search process 100A to be executed by the system and associated components of a social networking site in order to yield a search-specific, dynamically generated individual or company profile, in accordance with various aspects of the instant disclosure. The system and associated components of the social networking site may include server(s), processing unit(s), electronic storage device(s), database(s), etc. As will be described below, the results of process 100A renders a set of company or individual pages found in the search, in which each such page is a dynamically optimized to highlight the company or individual data most relevant to the individual user's submitted search criteria elements.

In particular, as shown in FIG. 1A, at block 10A of process 100A, social networking site user, who has a profile on the social networking site as well, initiates a search by accessing the search utility/module of the site. At block 11A, the searching user inputs a set of search criteria. Such criteria may contain a set of key words pertaining to the type or capability of the company or individual being sought by the user.

Once the search criteria have been entered, at block 12A, process 100A directs the system to look for stored profiles that have data that best fit or match the user-submitted search criteria. Depending on the search criteria, the system may search profiles specifically for companies 13A, individuals 14A, organizations 15A, and/or any combination thereof.

In particular, the system conducts a “best fit” profile search by employing a wide variety of weighted attributes that are used to rank the search results. For example, for a “company profile search,” the attributes could include company name, company industry, company location, company project attributes, members currently working at the company, company member attributes. The attributes are weighted depending on their importance in the search ranking. For example, when a brand name is noted in the search query, it will have a higher priority in ranking than the company owning the brand. In a different search that mentions a location, that element may have a higher weighting, because they may be more important than say, for example, project description attributes.

At block 18A, an interim list of relevant results is compiled by the system from company and individual data that best meet the user-submitted search criteria. Without displaying these interim results, process 100A directs the system, at block 19A, to choose profile(s), projects, and other posted data as well as extracts chosen profile data 110 that most closely fits the search criteria from the information posted by each company or individual on the interim results list.

At block 111A, the system then ranks the most relevant profile data/content for each company and individual and renders a set of dynamically generated profile pages 112 that are optimized to best respond to the search query and allows the searching user to view these pages. That is, the system again employs weighted attributes to rank the portions of content in each profile to determine what to display and where to display it on the page to optimize the presentation of useful content. For example, if the searching user enters a company search for “coke” in “best fit” profile search, the system ranks all the companies that include “coke” in their profile. Then, in the “ranking of the profile data,” the company's “coke” content is ranked based on, for example, company members who worked on “coke” projects, projects that the company did on “coke,” etc. Then, the highly ranked visual/written content is selected to be displayed prominently, such as, for example, company member profile pictures, member names, company projects, project titles.

Thus, these optimized profile pages pull in information from the basic profile(s) itself 110 and rank the content to intelligently reorganize, reformat, and/or repopulate the profile to provide a page with a display that specifically highlight the projects, achievements, collaborators, and other information that are most relevant to the searching user and his search query, As such, searching users are provided with search result profile pages that are customized to their needs. In particular, while other users conducting such searches might bring up any of the same individual, company, or organization profiles, the displayed profile pages would be correspondingly optimized to fit the search queries and the needs of the particular user conducting the search. Thus, the optimized profile pages displayed by the social network will look different from one search to another depending on the specific search criteria and/or searching user.

In another embodiment, FIG. 1B depicts user-generated search process 100B that searches for responsive information that is on the Internet, but not limited to a social network, in accordance with various aspects of the present disclosure. In particular, search process 100B directs the system to also look for connections to the searching user's own profile and to factor in any past projects/collaborations that the searching user has in common with the other profiles.

Along these lines, much like process 100A, at block 10B of process 1008, social networking site user initiates a search by accessing a search utility or module of the site and at block 11B, the searching user inputs a set of search criteria. Once the search criteria have been entered, at block 12B, process 100B directs the system to look for stored profiles that have data that best fit the user-submitted search criteria.

The system may then specifically search for companies 13A, individuals 14A, organizations 15A, and/or any combination thereof.

However, at block 16B, process 100B directs the system to additionally look for connections, 17B, to the searching user's own profile to factor in any past projects or collaborations that he has in common with the other profiles that it finds during the search. This relationship information may further refine the searching operations to provide the most relevant and customized list of results.

At block 18B, an interim list of relevant results is compiled by the system from company/individual data and relationship information that best meet the user-submitted search criteria. And, at block 19B, profile(s) and other posted data are chosen that most closely fits the search criteria from the information posted by each company or individual on the interim results list.

At block 111B, the system then ranks the most relevant profile data for each company/individual/relationship data and renders a set of dynamically generated profile pages 112 that are optimized to best respond to the search query and allows the searching user to view these pages.

It will be appreciated that process 100B may be further extended to include a search of the entire Internet to find information responsive to the search criteria and the relevant network results and to include additional notes in the display optimized profile pages.

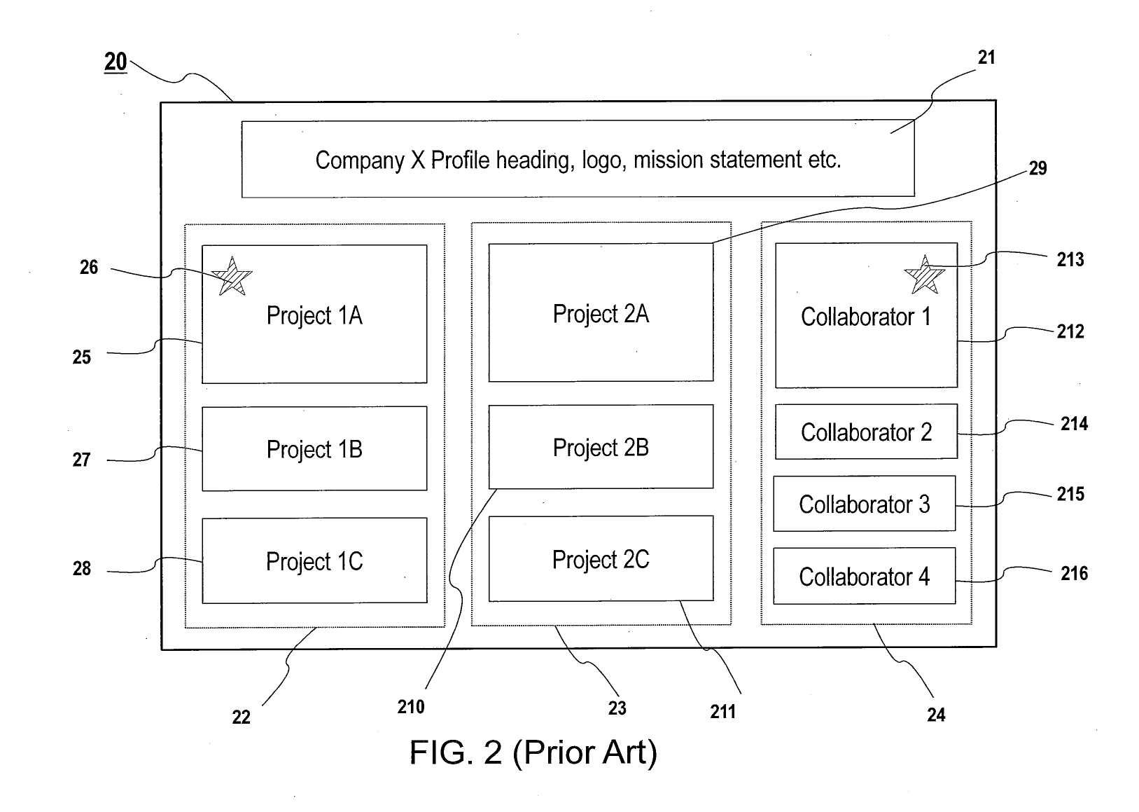

FIG. 2 depicts a representative conventional profile webpage 20 created by a company on a social network. As shown, the company could be a law firm specializing in litigation and tax law. Along with its basic information, the company has listed many projects and collaborators into its profile. The typical layout of profile webpage 20 will be static as it displays some company information on the screen, such as in area 21, which might include a brief paragraph on its areas of expertise, mission statement and history and background of the company. Also displayed may be projects, cases, or company awards that are most recent or most high-profile for the company.

Projects relating to litigation may be grouped together to the left of the screen in area 22. Three of the most recent projects of note are showcased. Project 1A, 25, may be their most recent and important, having won an accolade in the press (as indicated by icon 26). And, two more recent noteworthy projects, Project 1B, 27, and Project 1C, 28, are listed below this.

Projects relating to tax law may be grouped in the center of the screen in area 23. Three of the most recent and noteworthy are showcased. Project 2A, 29, is listed first followed by Project 2B, 210, and Project 2C, 211. Collaborators of note who have been instrumental in the success of these cases or projects are listed on the right of the screen in area 24 and are arranged in chronological order of their achievements. Collaborator 1, 212, who has won an award (as indicated by icon 213) is at the top, followed by Collaborator 2, 214, Collaborator 3, 215, and Collaborator 4, 216. Many more projects and collaborators may be included in the company's profile and a user can scroll down to see additional information displayed on the default company profile page.

This profile page would be displayed when a generic search for law firms is made without the embodiments of the systems and processes disclosed above. So, if a user searches specifically for the profile of this particular law firm, then this default profile page is viewed as the company set up the posted company information, projects, cases and collaborators, much like a company webpage on the Internet.

A typical webpage for a law firm on the Internet, however, would show the same static layout of information regardless of whether or not a search had specifically been made, for example, for law firms and litigation. The page that would come up on the website for a particular law firm on the Internet might have some litigation history but it might be buried underneath some other things that the firm was highlighting, such as some human resources and other transactions. As a result, the litigation information which could be of significant interest to the user conducting the search might not be readily visible.

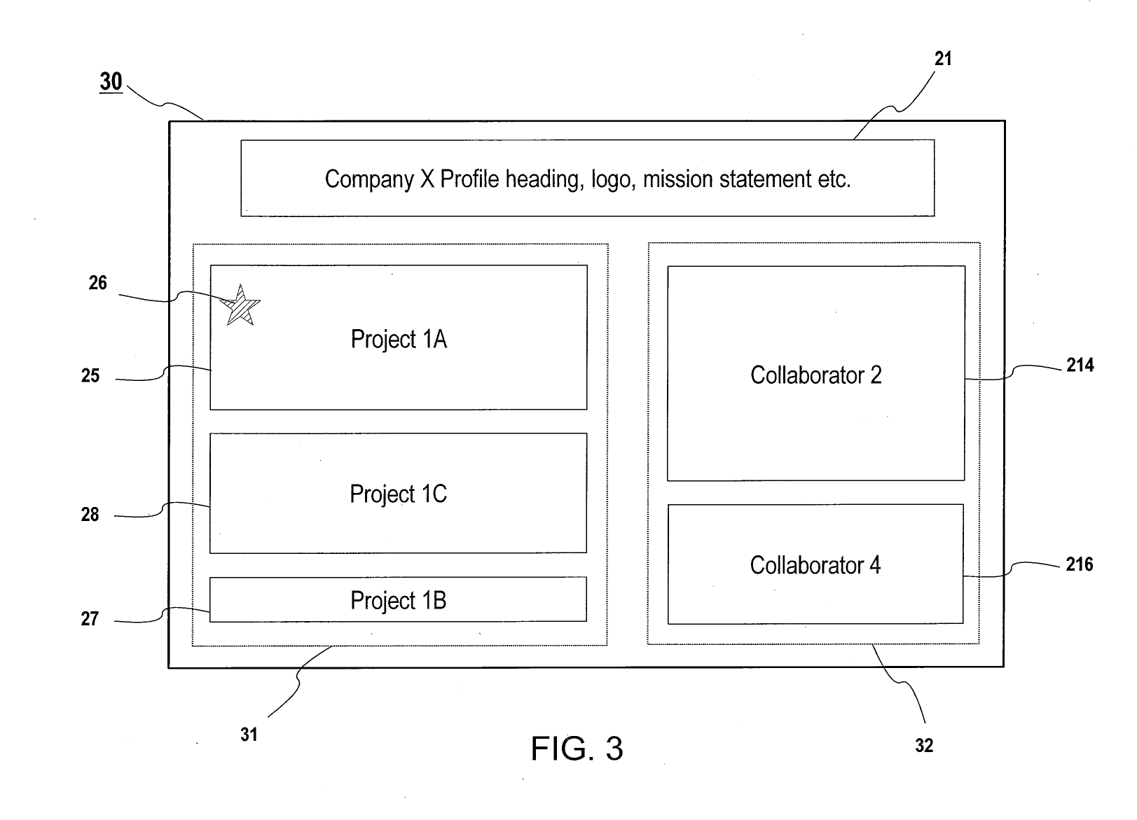

In contrast, a social networking site deploying the systems and processes embodied by the descriptions above, would render an optimized profile page when the search query includes elements other than a company name, such as, specific accomplishments, industries, type of work, and other attributes. Accordingly, FIG. 3 depicts a displayed search result embodied as a dynamically optimized profile page 30 of a company, in accordance with various aspects of the present disclosure.

That is, by virtue of the systems and processes described above, for the same law firm previously depicted in FIG. 2, the search result is rendered as a dynamically optimized profile page 30 customized for the user's specific search query for litigation law. Once again, some basic elements are displayed such as a brief paragraph in area 21, on its areas of expertise, mission statement and some history and background of the company. However, unlike the default profile webpage 20 described above, profile page 30 is optimized to highlight the projects and collaborators associated with litigation projects, based on the search query elements. That is, content is pulled in and ranked to intelligently reorganize, reformat, and/or repopulate the profile to provide a customized page that highlights information that is most relevant to the searching user and his search query.

For example, as shown in FIG. 3, the rendered dynamically optimized profile page 30 presents litigation projects/cases more prominently in order to be more responsive to the search query, while tax law reports may be subjugated to a scroll down area of the page. Specifically, profile page 30 is configured to display litigation on the left in area 31, with Project 1A, 25, which has won an award (as indicated by icon 26), is displayed at the top of area 31 indicating that it most closely fits the search criteria. Below that, listed in order of diminishing relevance, as determined by the search process, is Project 1C, 28, and Project 1B, 27.

Moreover, with regard to collaborative relationships, optimized profile page 30 presents the most relevant collaborators who worked on the projects displayed on the right in area 32. In this depicted example, Collaborator 2, 214 and Collaborator 4, 216, are showcased for the benefit of the searching user as best fitting the search query. Other collaborators are shown elsewhere because even though they may have won awards they have a lower relevance to the specific search query. In a profile having numerous projects, only a finite number of collaborators that most closely fit the search query will be displayed prominently on the first page of the profile, though the other profile information will be accessible to the user.

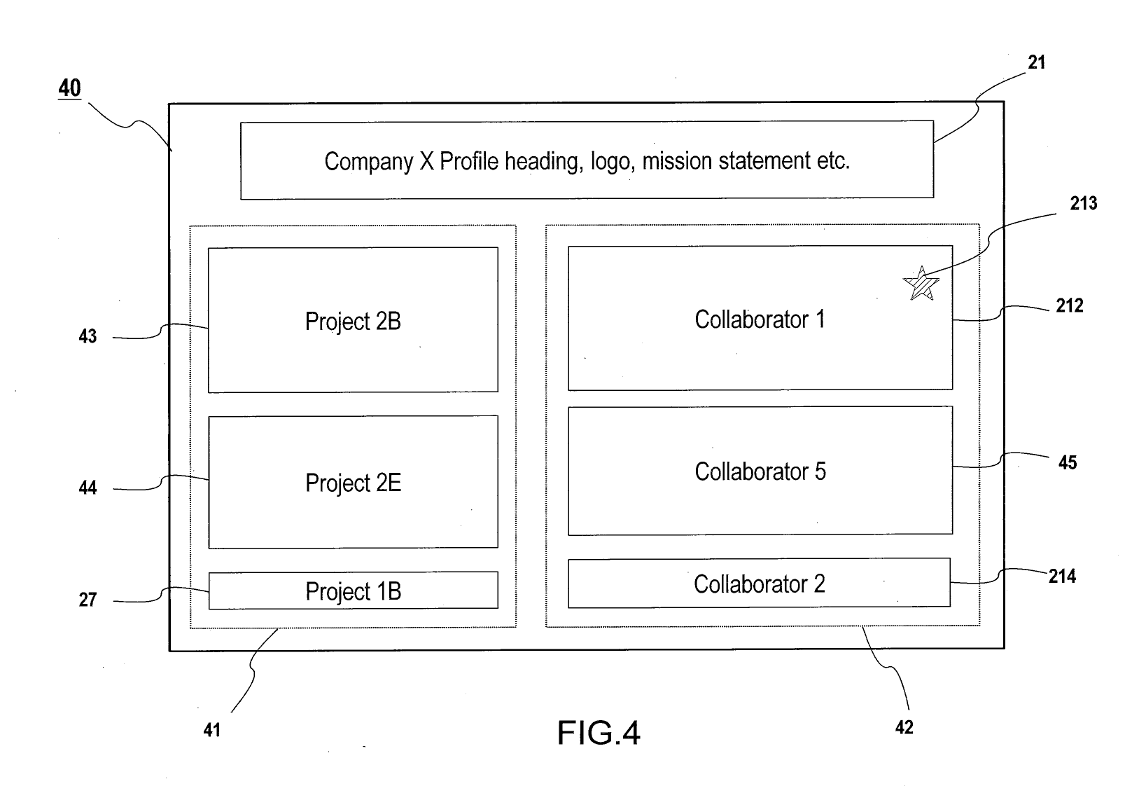

FIG. 4 depicts another dynamically optimized profile of a company based on a search query including other defining elements, in accordance with various aspects of the present disclosure. That is, in FIG. 4, the search result is rendered as dynamically optimized profile page 40 of the same law firm, however, in response to a different search query from a different user. Specifically, the search query specifically contains tax law elements which, in accordance with the systems and processes embodied by the descriptions above, provides the search result rendering of dynamically optimized profile page 40. As in FIGS. 2, 3, the basic information is displayed in area 21 of the page, however, the majority of the content is rearranged and dynamically filtered to provide the most pertinent information relevant to the search.

In particular, optimized profile page 40 is configured to display tax law projects in area 41. Project 2B, 43, is displayed at the top with Project 2E, 44 listed below in order of diminishing relevance, as determined by the search process. Moreover, while being a litigation project, Project 1B, 27, is listed at the bottom because it has a connective relationship to the searching user, which may assist in promoting the user to connect further with this law firm.

Moreover, optimized profile page 40 provides area 42, which is populated with collaborators on the projects. As shown, Collaborator 1, 212, who has won an award (as indicated by icon 213) is displayed first followed by Collaborator 5, 45 and Collaborator 2, 214 in order of diminishing relevance, as determined by the search process. Thus, content is pulled in and ranked to intelligently reorganize, reformat, and/or repopulate the profile to provide a customized page that highlights information that is most relevant to the searching user and his search query.

It will be appreciated that other projects and information may also be displayed and be accessible to the user, but they are not shown as prominently because they may not relate as closely to the search query, as determined by the search process. As such, the disclosed systems and processes are configured to take a default template for company or individual page and re-populate it with relevant projects and pull-in relevant high-achiever collaborators, the best and brightest get showcased for the benefit of the searching user and all of the users of the social network.

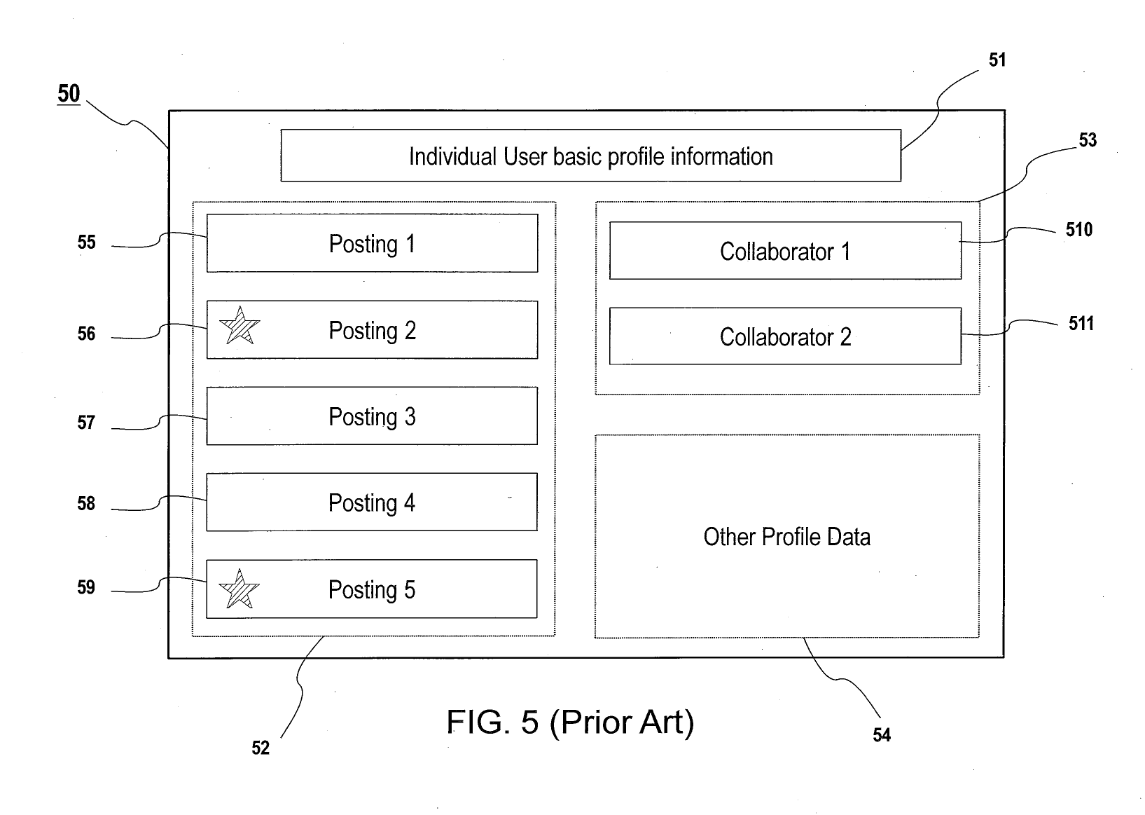

FIG. 5 depicts a default view of a representative conventional individual profile webpage 50. The typical static layout of template 50 includes the presentation of basic individual user information in area 51 and a postings area 52 populated with postings 55-59 relating to his day-to-day activities. Such postings 55-59 may include postings related to accomplishments in business, sport, and other leisure activities depending on the desires of the individual user.

Furthermore, to the right is area 53 showing collaborators on various project postings 510, 511, who may be team mates in sport, or business associates in work projects. Other profile data of an academic, resume, or family nature might be shown as well, in area 54. This individual profile page would be displayed when a generic search is made without the systems and processes described above.

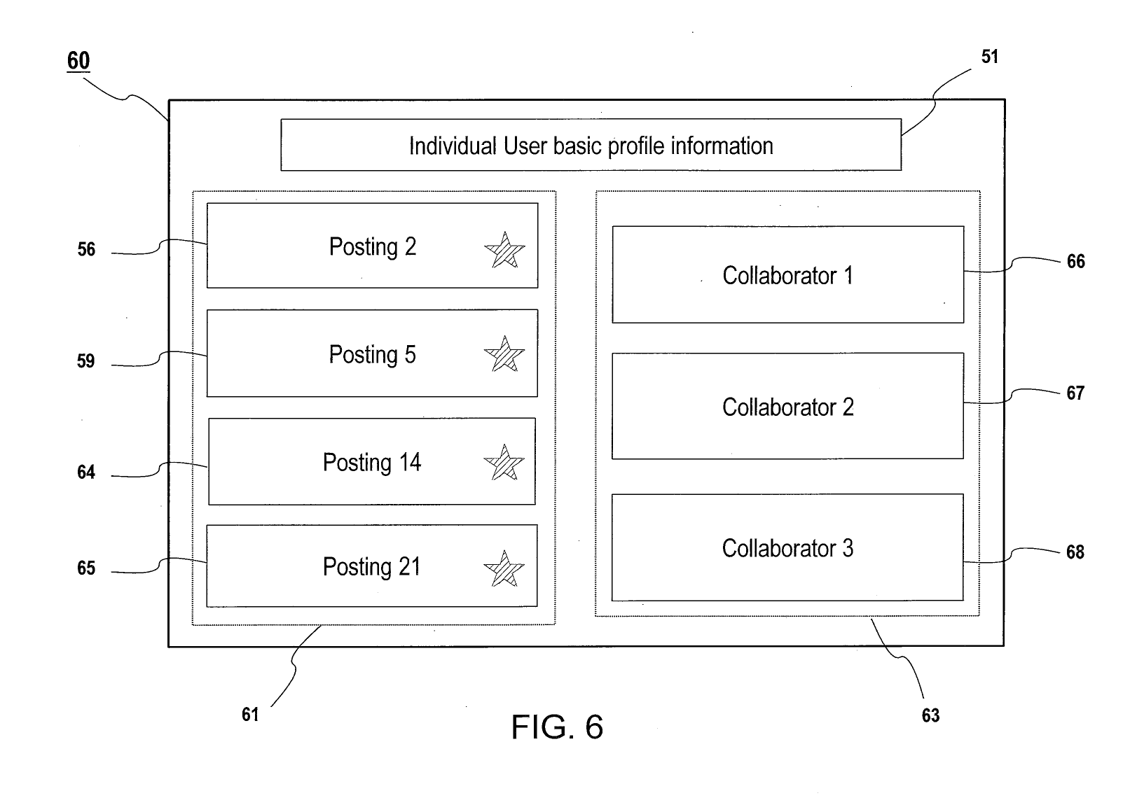

In contrast, FIG. 6 depicts a displayed search result embodied as a dynamically optimized profile page 60 which is re-formatted and customized to be specifically responsive to the elements in a search query, in accordance with various aspects of the present disclosure. Once again, by virtue of the systems and processes described above, for the same individual previously depicted in FIG. 5, the search result is rendered as a dynamically optimized profile page 60 customized for the searching user's specific search criteria.

In particular, besides some basic profile information, 51, his search-specific profile page 60 now highlights in prominence his postings 61 listing awards or success in sport, business, education; or other activities. Equally notable, this listing now includes several postings 64, 65, that were not visible on the default profile page 50.

Additionally, area 63 is designated for people who have collaborated with him in his award winning achievements, 66, 67, 68. These could be coaches or managers in sporting endeavors or colleagues in business projects, depending on the relevance to the search criteria. Less relevant achievements are downplayed.

Thus, by virtue of the configuration of the systems and processes described above, dynamically optimized profiles are automatically generated in response to a social networking site user's search query criteria and other related data profile. That is, the results are presented based on search-specific criteria in addition to the relationship to the searcher's profile information (e.g. industry, location, company, etc.) and/or searcher's contacts, connections, and collaborators.

Unlike prior art systems, which would require companies, organizations, and individuals to set up multiple profiles, the disclosed configuration dynamically selects relevant information and renders a profile that is customized to best fit the search query without additional work being required of the user conducting the search or the user, company, or organization that created the profile. The disclosed configuration will save users time and increase efficiency by displaying profile information that best fits their needs, while also highlighting and promoting projects and services of members of the social network and their collaborators.

It should be appreciated that other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method for providing dynamically optimized search results in conjunction with a social networking site, comprising:
receiving search criteria in a search utility of the social networking site;
executing a profile search of profile pages stored in the social network site that match the search criteria;
ranking the profile search results, in view of the search criteria, to compile an interim list of relevant profile information;
selecting highest ranking results of the interim list of relevant profile information and extract associated profile information therefrom;
ranking the extracted profile information, in view of the search criteria, to provide optimized content; and
displaying customized profile pages to present the optimized content,
wherein the customized profile pages are configured to prominently display the optimized content in accordance with the search criteria.

2. The computer-implemented method of claim 1, wherein the profile pages comprise individual profile information, company profile information, and/or organization profile information.

3. The computer-implemented method of claim 2, wherein the profile information includes at least one or more of the following: identifying information, project information, award information, specialization information, collaboration information, service announcements, activity information, event information, employment information, mission statement information, or education information.

4. The computer-implemented method of claim 1, further comprising searching collaborative relationship information.

5. The computer-implemented method of claim 1, wherein the ranking of the profile search results includes applying numerous attributes that are weighted based on their degree of relevance to the search criteria.

6. The computer-implemented method of claim 1, wherein the ranking of the extracted profile information includes applying numerous attributes that are weighted based on their degree of relevance to the search criteria.

7. The computer-implemented method of claim 1, wherein the displayed customized profile pages are configured to reformat and/or repopulate the profile pages to visually highlight the optimized content.

8. A system for providing dynamically optimized search results in conjunction with a social networking site, comprising:
a search utility of the social networking site configured to receive search criteria;
a processing unit configured to execute a profile search of profile pages stored in the social network site that match the search criteria;
the processing unit configured to rank the profile search results, in view of the search criteria, to compile an interim list of relevant profile information;
the processing unit configured to select highest ranking results of the interim list of relevant profile information and extract associated profile information therefrom;
the processing unit configured to rank the extracted profile information, in view of the search criteria, to provide optimized content; and
a display unit configured to display customized profile pages to present the optimized content,
wherein the customized profile pages are configured to prominently display the optimized content in accordance with the search criteria.

9. The system of claim 8, wherein the profile pages comprise individual profile information, company profile information, and/or organization profile information.

10. The system of claim 9, wherein the profile information includes at least one or more of the following: identifying information, project information, award information, specialization information, collaboration information, service announcements, activity information, event information, employment information, mission statement information, or education information.

11. The system of claim 8, further comprising searching collaborative relationship information.

12. The system of claim 8, wherein the ranking of the profile search results includes applying numerous attributes that are weighted based on their degree of relevance to the search criteria.

13. The system of claim 8, wherein the ranking of the extracted profile information includes applying numerous attributes that are weighted based on their degree of relevance to the search criteria.

14. The system of claim 8, wherein the displayed customized profile pages are configured to reformat and/or repopulate the profile pages to visually highlight the optimized content.

15. A computer-readable medium for providing dynamically optimized search results in conjunction with a social networking site, the medium having information recorded thereon which, when executed by a computer, causes the computer to perform the following:
receive search criteria in a search utility of the social networking site;
execute a profile search of profile pages stored in the social network site that match the search criteria;
rank the profile search results, in view of the search criteria, to compile an interim list of relevant profile information;
select highest ranking results of the interim list of relevant profile information and extract associated profile information therefrom;
rank the extracted profile information, in view of the search criteria, to provide optimized content; and
display customized profile pages to present the optimized content,
wherein the customized profile pages are configured to prominently display the optimized content in accordance with the search criteria.

16. The computer-readable medium of claim 15, wherein the profile pages comprise individual profile information, company profile information, and/or organization profile information.

17. The computer-readable medium of claim 16, wherein the profile information includes at least one or more of the following: identifying information, project information, award information, specialization information, collaboration information, service announcements, activity information, event information, employment information, mission statement information, or education information.

18. The computer-readable medium of claim 15, further comprising searching collaborative relationship information.

19. The computer-readable medium of claim 15, wherein the ranking of the profile search results and the ranking of the extracted profile information includes applying numerous attributes that are weighted based on their degree of relevance to the search criteria.

20. The computer-readable medium of claim 15, wherein the displayed customized profile pages are configured to reformat and/or repopulate the profile pages to visually highlight the optimized content.
